(19) United States
(12) Patent Application Publication
(10) Pub. No.: US 2008/0136066 A1
(43) Pub. Date: Jun. 12, 2008

(54) Apparatus and method for inductive heating a workpiece using an interposed thermal insulating layer

(75) Inventors: Bruce F. Taylor, Worthington, OH (US); Robert Kadykowski, New Richmond, OH (US); Rene Larive, Grand Mere (CA); Elisabeth Leclerc, Grand-Mere (CA); Dany Larive, Grand-Mere (CA); Timothy W. Womer, Edinburg, PA (US)

Correspondence Address: ROBERT J HERBERGER;MCLAUGHLIN AND MCNALLY, 500 CITY CENTRE ONE, P O BOX 507, YOUNGSTOWN, OH, 445010507, US

(73) Assignees: Xaloy, Incorporated; Comaintel, Incorporated

(21) Appl. No.: 11/599,694

(22) Filed: Nov. 15, 2006

(51) Int. Cl. B29C 47/80; H05B 6/14

(52) U.S. Cl. 264/486; 425/378.1; 264/454; 264/457

(57) ABSTRACT

Disclosed herein is an apparatus and method with inductive heating of an electrically conductive workpiece such as a barrel used in molding or extrusion, having a layer of thermal insulation interposed between the induction windings and the workpiece, and using alternating current (AC) at an elevated frequency. Further, variable pitch induction windings may be used to generate a non-uniform and calculated heat input profile, such as to compliment the configuration of a screw for transporting material through the barrel.

### FIELD OF THE INVENTION

This invention relates to an apparatus and method for heating an electrically conductive workpiece by inductive heating. More particularly this invention relates to inductive heating of a ferrous workpiece, such as an extrusion or molding barrel, using alternating current (AC) at an elevated frequency. While the application of the invention to barrel heating is described in detail herein, this invention can include the heating of any workpiece through which material flows, provided said workpiece is responsive to AC inductive heating and provided said workpiece can be substantially surrounded by an induction coil and an interposed thermal insulating layer.

### BACKGROUND OF THE INVENTION

Referring to FIGS. 1 and 2, it is commonly known how extruders and molding machines can take fluids or solids and more commonly the latter, such as plastic or magnesium, in such forms as pellets, powder, granules, or chips, (hereinafter collectively referred as processed “material” 1) fed through a feed port 3 in a cylindrical metal tube or barrel 5 and then mixed, heated, and perhaps melted into a homogeneous molten state. Of course, there are various means of molding, such as injection molding, blow molding, injection blow molding, and extrusion blow molding, all of which are herein generally referred to as “molding”, and to all of which the present invention may be applied. With extruders and molding machines, a screw 7 rotates within the barrel 5 to ingest the material and transport it along a helical path toward the exit at the nozzle or die end 9. Shear heat Q_{S} is generated by frictional interaction between the material, screw 7 and barrel wall. This shear heat, combined with heat conducted into the material Q_{P} from the heated surrounding barrel melts the material 1. The molten material is then mixed and compressed before exiting.

Electrical contact resistance heaters 11, of which there are many types, are typically used to heat the barrel 5 by external circumferential contact. Frequently used types of contact resistance heaters include those commonly referred to in the art as mica band-heaters, ceramic band-heaters, and cast aluminum heaters, which are also referred to generally as cast-in heaters. More rarely barrels are heated by other means, such as by hot oil circulated within channels in the barrel wall or within separate contacting elements through which the oil circulates. Due to the added cost and complexity, and the slower control response of the oil's thermal mass, oil-heated devices are limited to special applications, such as the processing of thermosets, including phenolics, ureas, and rubber.

Referring still to FIGS. 1 and 2, ohmic heat generation within contact resistance heaters 11 is typically accomplished by applying a constant 50-60 Hz AC voltage across an array of resistance heaters 11 electrically connected in series and/or parallel. Closed-loop control of the barrel's temperature is then accomplished in sequential axial zones 13, often three to six zones, and sometimes more, of approximately equal length, by means of one or more thermocouples 15 embedded within the barrel wall 17 in each zone 13, one temperature controller per zone (not shown, typically a stand-alone controller, PLC-based controller, or PC-based controller, employing some level of PID control), and one or more relay-activated power contactors 19 per zone 13. For practical reasons typical controllers turn power “on” and “off” to the resistance heaters 11, in thermostatic fashion, in order to maintain the barrel zone temperatures within an acceptable range (as opposed to analog adjustment of the source voltage, which is not cost-effective).

To prevent them from overheating, resistance heaters 11 are typically left exposed to the surrounding environment 21, i.e. ambient air or if enclosed, chilled-water or forced-air cooled. The surrounding environment 21 absorbs heat from the resistance heaters 11, reducing their efficiency, which is defined herein as E_{H}=(Q_{E}−Q_{L})/Q_{E}(where Q_{E} is the heat generated in the resistance heaters 11; and Q_{L} is the heat loss from all external surfaces 23, 25 exposed to the surrounding environment 21 along the length of the barrel 5). More specifically, as illustrated in FIG. 2, heat lost Q_{L} from the exterior exposed surfaces can be defined as Q_{L}=Q_{H,CV}+Q_{H,RD}+Q_{B,CV}+Q_{B,RD} (where Q_{H,CV} represents the natural convection losses to the surrounding environment 21 from exposed heater surfaces 23; Q_{H,RD} represents radiation losses to the surrounding environment 21 from exposed heater surfaces 23; Q_{B,CV} represents the natural convection losses to the surrounding environment 21 from exposed barrel surfaces 25; and Q_{B,RD} represents radiation losses to the surrounding environment 21 from exposed barrel surfaces 25).

The remaining components of the overall heat balance can be defined herein as follows: Q_{H,T} representing the heat absorbed by each heater 11 as its temperature rises; Q_{H,CO} representing the heat flow across the interface between each heater 11 and the barrel 5; Q_{B,T} representing the heat absorbed by the barrel 5 as its temperature rises; Q_{P} representing the heat consumed by the process to heat and/or melt the flowing material 1; and finally Q_{CD,A} representing the heat transferred axially through the barrel wall 17 to adjacent cooler regions of the barrel 5 and to the machine housings at both ends of the barrel 5.

In a typical heat balance equation, heat absorbed Q_{P} by the processed material, plus heat losses to the machine housings Q_{CD,A}, and from the barrel surface Q_{L}, must substantially equal the sum of the heat generated by process shear Q_{S} and the heat input from the heaters Q_{E}. For illustration purposes only, referring to FIGS. 1, 2 and 3, assuming a typical resistance-heated injection molding application known in the art, with a screw diameter in the range of about 50 mm, as an example, about 5 kW of process heat Q_{P} may be required (which accounts for about 50% of the total required heat generation (Q_{E}+Q_{S})) to melt the flowing material 1; while heat losses Q_{L} from the exposed external surfaces 23, 25 can be about 4 kW (approximately 40% of the total energy consumption (Q_{P}+Q_{CD,A}+Q_{L})) and heat losses Q_{CD,A} to the machine housings can be about 1 kW (the remaining approximately 10% of the total energy consumption). On such an application, the heat generated by process shear Q_{S} between the process material 1, screw 7 and barrel wall 17 can be about 4 kW (approximately 40% of the total heat generation), thereby requiring the remaining approximately 6 kW heat input Q_{E} (approximate 60% of the total heat generation) supplied by the heaters 11. The resistive heating efficiency E_{H} in this example would therefore be about 33% (E_{H}=(Q_{E}−Q_{L})/Q_{E} as described above, or (6 kW−4 kW)/6 kW). If the barrel surface heat loss Q_{L} is eliminated, the efficiency (as defined herein) would then increase to 100%, and the required heater power consumption Q_{E} would decrease by 67% (from 6 kW to 2 kW). Therefore, substantially reducing barrel surface heat losses Q_{L} to significantly improve heating efficiency is an important objective of the present invention and a significant improvement over the prior art.

Referring now to FIGS. 2 and 4, improved efficiency can be achieved by wrapping a layer of effective thermal insulating material 27 around the resistance heaters 11 to virtually eliminate barrel surface heat losses Q_{L}. In practice this has been done using an insulating blanket. However, this corrective action often causes the resistance heaters 11 to overheat and fail. Also, it does not overcome problems caused by the excessive thermal mass of the resistance heaters, more specifically the product of the heaters' mass and heat capacity (i.e. btu/lb-° F. or joules/kg-° C.). High thermal mass slows control response and impedes process uniformity. Therefore, due to their mass, material of construction, and direct contact with the barrel 5, resistance heaters 11 add a substantial thermal heat sink that further dampens heating response. This is particularly the case with cast-in heaters, which need heavier walls sufficient to permit the channeling of cool air or chilled water. These heavy walls add to the thermal mass of the cast-in heaters, as does the mass of water or air circulating through them.

Referring next to the graph shown in FIG. 5, when raising the barrel temperature 29, the resistance heater's temperature 31 must first be raised to create a gradient or differential 33 before the barrel temperature 29 responds. Likewise, when reducing the barrel temperature 29, the temperature 31 of the resistance heaters 11 must drop below the barrel temperature 29 before it will follow. Therefore, because resistance heaters 11 transfer heat to the barrel 5 by conduction Q_{H,CO} across an intervening contact area, the heaters must be significantly hotter than the barrel 5 when heating it, and cooler than the barrel 5 before it can be cooled. The thermal mass of resistance heaters 11 and the required temperature differential 33 between them and the barrel 5 therefore effect the response time of the barrel's temperature control.

Continuing to refer to FIG. 5, resistance heaters 11 are typically controlled by turning power “on” and “off”, using a constant voltage source. Using variable voltage control in each zone is prohibitively complex and expensive. The temperature 31 of resistance heaters 11 must therefore swing between two extremes 35, 37 even when the process is stable. In practice this often leads to substantial swings in barrel temperature 29 between two narrower extremes 39, 41 with a span 43 of as much as 5% or more above and below the target operating temperature 45.

Referring now to test results graphically illustrated in FIG. 6, the average temperature 47 of a barrel with three zones 13 of resistance heaters 11 was monitored with thermocouples 15 located at various positions along the barrel's length during an actual injection molding application producing 40 gm polypropylene parts using a 30 second cycle time 49. At room temperature, pelletized material 1 was introduced into the feed port 3 at the beginning of each 30-second machine cycle, causing a repeatable drop in average barrel temperature 47 every cycle. Were the resistance band-heaters 11 able to quickly add enough heat Q_{P} to the process, the average barrel temperature 47 would have oscillated within a narrower band. Instead, as is often the case with resistive-heated injection molding applications, the resistance band-heaters 11 were unable to keep up with the process and fell out of sync. The longer the “on” 51 and “off” 53 portions of the control interval 55, the more heat is lost, consumed and added per cycle, thereby producing a larger swing in the process temperature. Therefore, in practice, the thermal mass of resistance band-heaters 11 often lengthens the control interval 55 from seconds to minutes. This is substantiated by the example illustrated in FIG. 6, where the band-heater control interval 55 exceeds ten minutes, and produces a large cyclical swing 57 of about 20° F. in the average barrel temperature 47.

In high electrical demand regions, electricity rates, i.e. cost/kW-hour, typically increase with the peak demands monitored by utility companies. The exact billing basis varies by region, and might for example be based on the peak usage during a billing cycle, or on the ratio of the peak usage to the average usage. Regardless, the peak value is likely to be computed over a period of multiple minutes. For example, with a typical utility company, peak demand might be average over 30-minute intervals, and the billable monthly peak demand will be the highest of all the 30-minute averages for the billing month. Also, if the customer's use of electricity is intermittent or subject to violent fluctuations, a 5 minute or 15-minute interval may be used instead of the 30-minute interval. Accordingly, a control interval 55 of many minutes may increase peak demand, and thus electricity costs, while a control interval equal to the machine cycle (which is less than a minute in most cases) likely will not, since the machine's average and peak electricity usage will generally be the same. It is therefore a further objective of the present invention to enable the addition of enough heat to the process Q_{P} quickly enough to enable the control interval 55 of the molding application to be equal to or less than the machine cycle time 49, thereby reducing process temperature swings 57 and the electrical peak demand.

Referring still to FIGS. 5 and 6, because resistance heaters 11 must be hotter than the barrel 5 when heating it, the heater temperature 31 must be raised beyond the melt point of the material 1 being extruded or molded. This temperature elevation further increases system heat losses Q_{L} to the surrounding environment 21 and to the upstream and downstream machine housings Q_{CD,A} in contact with the barrel 5, reducing efficiency, as well as the reliability and life of the contacting equipment at the machine housings at ends of the barrel 5. Therefore, an objective of the present invention is to reduce the maximum barrel surface temperature 59 by preventing the heating device from itself getting hot and maintaining the exposed surfaces 23, 25 at temperatures safe to the touch.

Referring again to FIGS. 1 and 2, uniform contact between resistance heaters 11 (particularly band-heaters) and the barrel 5 is important to prevent hot-spots and heater failures. Band-heaters 11, therefore, most commonly have a relatively small “length to diameter” ratio, 61, 63 respectively. This often means three or more interconnected band-heaters 11 are required per control zone 13, thereby in such cases totaling nine or more band resistance heaters 11 at select portions over the length of the barrel 5, and frequently as many as 15 to 30. This more common system arrangement makes it difficult to promptly detect and replace a single failed band-heater 11. However, any delay in detection and replacement can produce defective product and/or constrained throughput. In addition to labor and parts costs associated with replacement, production is also lost while waiting for the barrel 5 to cool, and then disassembling and replacement, and finally waiting for the barrel 5 to re-heat. In practice, band-heaters 11 can also become covered with excess plastic emanating from the manufacturing process, such as through excessive clearances around dies or nozzles, or at connections to screen changers on extrusion machines, or at vent holes that can be located along the length of the barrel on vented extrusion machines, thereby making proximate band-heaters more susceptible to overheating and premature failure. It is therefore yet another objective of the present invention to minimize the number of individual heating units, while inherently increasing their reliability and reducing susceptibility to overheating due to material overflow.

Referring still to FIGS. 1 and 2, sufficient and uniform contact pressure between resistance heaters 11 and the barrel 5 is critical to facilitate the desired heat flow across the interface Q_{H,CO} and to prevent overheating and failure of the resistance heaters 11. As resistance heaters 11 and the fasteners that constrain them age, the contact pressure and its uniformity can diminish, which can gradually reduce the heater's life and/or the machine's throughput rate, if the rate is constrained by heating capacity. It is therefore another objective of the present invention to eliminate the need for any contact pressure between the heating device and the barrel 5, as well as to effectively eliminate sensitivity of the heating device's heat transfer performance and reliability to small variations in the clearance therebetween.

Referring next to FIG. 7, resistance heaters 11 in the prior art are often constructed in two semi-circular halves 65, 67 that bolt together, or that hinge open and closed via diametrically-opposed longitudinal seams 69, 71. The regions near these seams 69, 71, and possibly near the electrical connection terminals 73, are unheated. The barrel within these regions 75 is therefore not directly heated, thereby wasting surface area, across which heat transfer could otherwise occur. This reduces the capacity of such two-part resistance heaters 11 and introduces circumferential barrel temperature variations. In practice, this problem can be overcome by offsetting the seams of adjacent resistance heaters 11 to avoid development of a continuous cool seam along the length of the barrel 5. However, installers and maintenance personnel will occasionally overlook this design flaw and not position the heaters correctly, producing a relatively cool streak along part or all of the barrel's length which can diminish the temperature uniformity of the molten material stream. It is therefore another objective of the present invention to provide uniform heating around the entire circumference of the barrel 5.

Referring now to FIGS. 1, 2 and 4, regarding the resistance heaters 11 currently in use, embedded electrical heating elements do not extend right to their upstream and downstream edges 77 and, as previously discussed, to reduce the risk of inadequate or non-uniform contact pressure, these resistance heaters 11 often come in relatively short lengths. Therefore, there are often multiple unheated gaps 79 between adjacent heaters 11. More specifically, there are typically three or more unheated gaps 79 per control zone 13. These gaps 79 represent wasted surface area across which heat transfer would ideally occur but cannot, further reducing the heaters' capacity. In addition, the application of heat in a plurality of discontinuous segments is not ideal for process uniformity. In order to maintain the processed material at optimal averaged temperatures along the barrels length, the processed material must be exposed to higher than optimal temperatures at the center of resistance heaters 11, to compensate for exposure to lower temperatures at the gaps 79. It is therefore another objective of the present invention to minimize the number of unheated gaps 79 along the length of the barrel 5, preferably to less than or equal to the number of control zones 13.

Referring now to FIGS. 8a-c and 9a-c, the typical process of mixing, heating, and/or melting material 1 within a barrel 5 includes a helical screw 7 whose geometry is often optimized for the process, based on multiple factors, including but not limited to the material's thermal and physical properties, as well as the desired throughput rate. The screw geometry includes such parameters as a screw core with a root depth 81 and main helical flight 83 that can have a constant or variable pitch 85. Of course, the screw geometry affects the amount and distribution of heat generated within the process by shear Q_{S}, and therefore the amount and optimal distribution of heat Q_{E} that must be supplied externally to the process to satisfy the overall heat balance as discussed. In practice heat Q_{E} is conventionally applied in discrete zones 13 using resistance heaters 11, producing a step-wise heat input profile that may not optimally complement the varying requirements of the process along various sections of the barrel's length L.

Extrusion and molding screws 7 commonly include multiple functional sections, such as feed “A”, transition “B”, metering “C”, mixing “D”, barrier “E”, reorientation “F”, and vent “G” sections, as are well known in the extrusion and molding art. Were a more smoothly varying means available to add heat Q_{E} to the barrel 5, those skilled in the art would have the freedom and opportunity to optimize the axial heat distribution Q_{E} in concert with the screw geometry, to improve upon the performance of extruding and molding operations. More specifically, the ability to smoothly and contiguously profile the heat input Q_{E} would allow those skilled in the art to better profile the screw's functional sections, and/or to more optimally transition from one functional section to another. It is therefore another objective of the present invention to enable a more smoothly and contiguously varying heat input profile Q_{E} along the axis of the barrel 5.

Referring now to FIGS. 10 and 11, as will be described in more detail in the preferred embodiment, magnetic induction heating 87 of an electrically conductive workpiece, such as the barrel 5, can be used with or without contact between the induction windings 89 and the barrel 5. Electrical current “I” passed through the induction windings 89 will generate a magnetic field whose flux lines 91 pass through the barrel wall 17. When the current's direction is alternated at high frequency, eddy currents 93 are generated within the wall 17 of the barrel 5, producing localized, direct heating Q_{E} of the barrel 5. The fact that induction heating is not dependent upon direct contact between the windings 89 and the barrel 5 permits further improvements that are exploited by the present invention to meet the many objectives listed above.

Although the use of magnetic induction using alternating current to heat electrically conductive workpieces is known, including induction heating of barrels 5 used to heat materials such as plastic or metals in extrusion and molding applications, the present invention provides many distinct advantages over the prior art. For example, British Pat. No. 772,424 to Gilbert discloses a plurality of induction units assembled around a barrel, each consisting of a single multi-turn coil or winding. Although the winding is enclosed in a heat resisting and electrically protective sheath, each is surrounded by a magnetisable ferrous shell, and no effective thermal insulating layer is interposed between the barrel and each winding unit. In fact, between adjacent windings the magnetisable shell of each unit makes direct contact with the barrel. Therefore, the windings and magnetisable shell described therein are thermally coupled to the barrel, increasing the thermal mass of the system, as well as providing a path for dissipation of heat to the environment through radiation and natural convection. Further, Gilbert's use of windings having multiple turns with a relatively low frequency alternating current (25 to 100 Hz), would mandate a larger number of winding turns (10 to 30 times more) than would otherwise be the case with higher operating frequencies (10 to 40 kHz).

U.S. Pat. No. 5,025,122 to Howell discloses an induction coil assembly for heating associated workpieces inserted therein, using a plurality of interleaved, selectable induction coils to control the operable power and heated length in discrete increments. This invention also does not use interposed thermal insulating material between the coil and workpiece to reduce the apparatus' thermal mass and heat losses to the environment.

U.S. Pat. No. 5,799,720 to Ross, et al., pertains to transferring molten metal from a reservoir by gravity to a mold for casting molten metal. The Ross assembly uses a casting nozzle having an electrically conductive top wall and bottom wall. An inductive heater is positioned to heat the top and bottom walls of the nozzle. A layer of insulation is positioned between the inductive heater and the wall surfaces and a magnetic shield is provided to partially surround the inductive heater to direct magnetic flux into the nozzle. Also, like Gilbert's British Pat. No. 772,424 and Howell's U.S. Pat. No. 5,025,122, this patent does not envision varying the pitch of the induction windings to complement a screw's flow profile.

Finally, U.S. Pat. Nos. 6,717,118, 6,781,100 and 7,041,944, all to Pilavdzic et al, describe and favor an apparatus that combines inductive and contact resistance heating of a workpiece, such as a barrel. A layer of thermal insulation interposed between the coil and barrel is not suggested, and the invention specifically favors a coiled electrical conductor that is in thermal communication with the heated article in order to directly transfer any resistive heat generated in said coiled electrical conductor to said article. As such, among other things, Pilavdzic's inventions do not use or envision an interposed layer of thermal insulation to reduce the apparatus' thermal mass and heat losses to the environment.

The present invention is directed to overcoming the numerous limitations and problems set forth above.

### SUMMARY OF THE INVENTION

The apparatus and method described herein use one or more induction coils, each comprising a helically wound electrical conductor surrounding a thermal insulating layer of non-electrically conductive material to heat an enclosed electrically conductive workpiece, such as a metal extrusion or molding barrel 5. The helical winding is commonly referred to as a “tunnel coil”. The induction tunnel coil heats the workpiece through the interposed thermal insulating layer.

By interposing a thermal insulating layer between the induction coils and the heated workpiece, heat generated within the workpiece cannot substantially escape through the insulation to the environment. This raises the heating efficiency and protects the external induction windings from elevated temperatures. Maintaining the induction coil's windings at lower temperatures reduces their electrical resistance to further reduce resistive losses, which in turn increases the system's overall energy efficiency.

Another unique characteristic of induction heating using a helical tunnel coil in this invention is that the distribution of transferred energy along the length of the workpiece is inversely proportional to the pitch of the helix. By varying the pitch of the windings additional embodiments of the present invention are envisioned that can profile the heat generation along the length of an enclosed workpiece, in an intentionally non-uniform, predictable manner to complement and optimize transition of the processed material from solid to molten phases. In other words, with extruder and molding applications this invention allows the distribution of heat along the barrel length within a controlled zone to optimally match the geometry of the conveying screw and processing objectives. For example, the conveying screw might be designed in concert with the winding profile to produce an optimal temperature profile along the flow path of the material being processed. Establishing the optimal axial temperature profile can minimize shear and reduce screw drive horsepower, while also reducing internal barrel wear to increase screw, barrel and drive motor life, and/or improves the uniformity of material properties influenced by temperature to produce extruded or molded parts of more uniform quality. In the case of more stable and predictable process applications, this invention may use a single profiled controlled heating zone over the entire barrel, where previously three or more controlled zones would conventionally be required. And, where more uniform full-length heating is needed to permit relatively uniform and fast barrel preheating, and/or where more flexible response to process disturbances is needed, two controlled zones might be sufficient, where three or more were conventionally used.

### BRIEF DESCRIPTION OF THE DRAWINGS

Having thus generally described the nature of the invention, reference will now be made to the accompanying drawings used to illustrate and describe the preferred embodiments thereof. Further, these and other advantages will become apparent to those skilled in the art from the following detailed description of the embodiments described herein when considered in the light of these drawings in which:

FIG. 1 is an elevational view of a typical molding barrel using conventional resistance heaters in the prior art;

FIG. 2 is a sectional view showing the overall heat balance of a lengthwise segment of the typical molding barrel shown in FIG. 1;

FIG. 3 is a graphical illustration of the typical time-averaged power distribution during production conditions, using three separate discrete control zones along the length of the barrel shown in FIG. 1;

FIG. 4 is a sectional view showing the overall heat balance of a lengthwise segment of the typical molding barrel shown in FIG. 1, but in this case with the barrel and conventional resistance heaters shown surrounded by a thermal insulating blanket;

FIG. 5 is a graph showing temperature response versus time for a resistance heater thermally communicating with the adjacent barrel of the molding apparatus shown in FIG. 1;

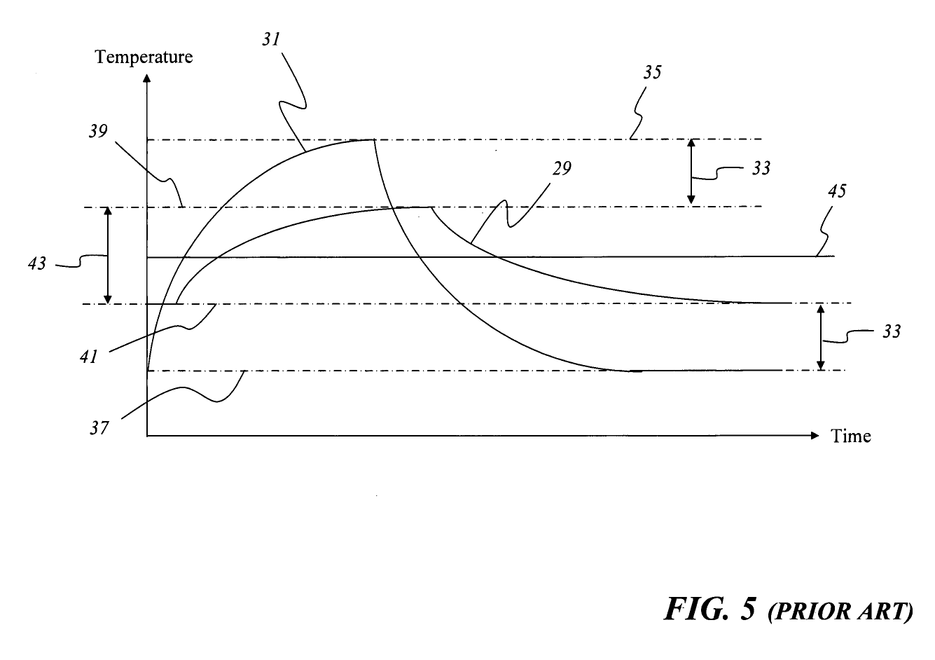

FIG. 6 graphically shows barrel temperature measurements obtained during operation of an injection molding machine, and shows response and control differences between heating the barrel using contact resistance heaters versus induction heaters;

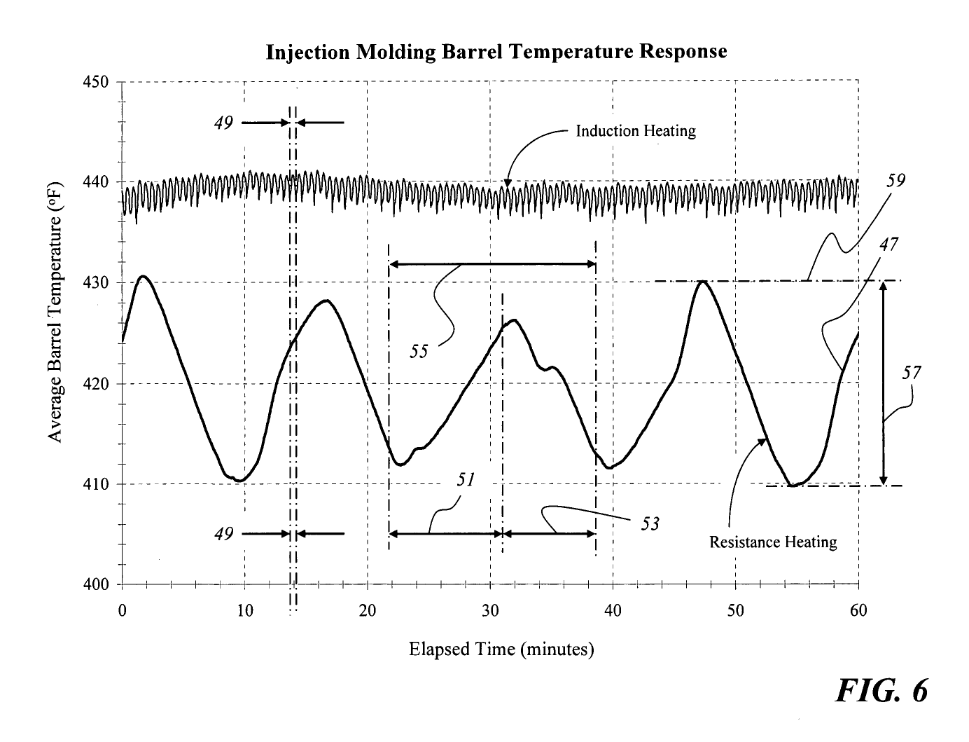

FIG. 7 is a sectional end view of the conventional resistance heaters used with the molding barrel shown in FIG. 1;

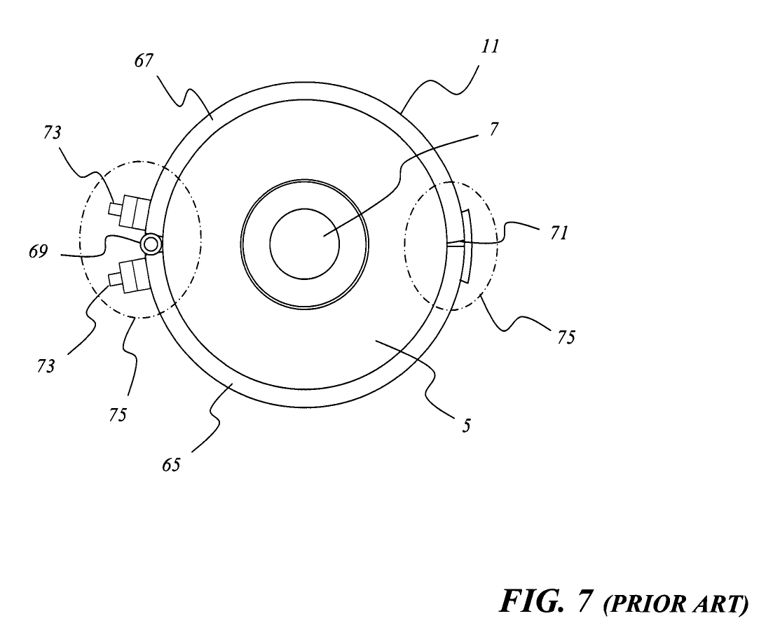

FIGS. 8a, 8b and 8c are partial sectional lengthwise views of a typical molding barrel with the external heaters removed and various molding screws shown therein;

FIGS. 9a, 9b and 9c are partial sectional lengthwise views of a typical extrusion barrel with the external heaters removed and various extrusion screws shown therein;

FIG. 10 is a lengthwise view of a segment of a molding or extrusion barrel surrounded by an induction tunnel coil;

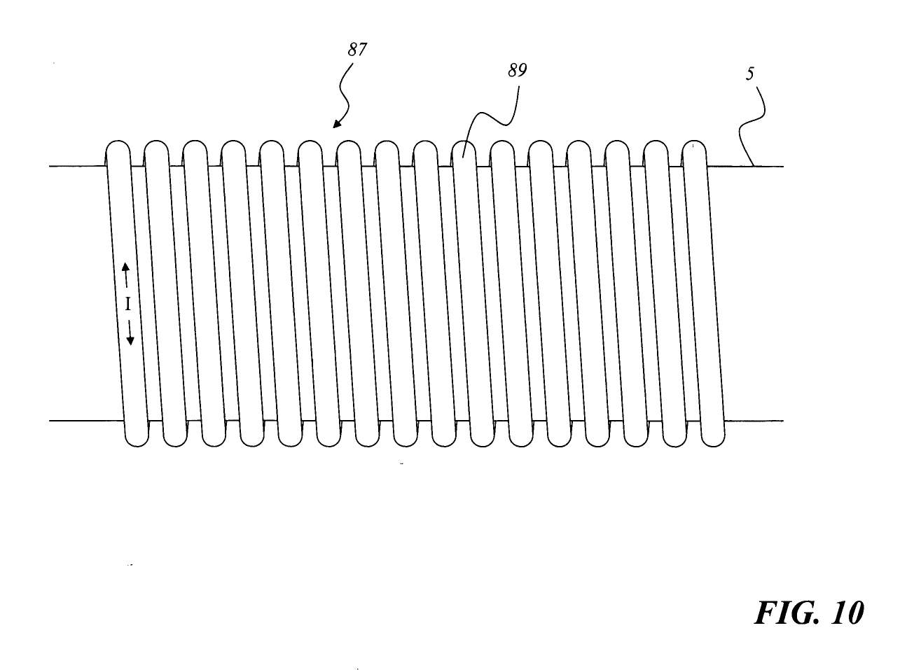

FIG. 11 shows a sectional view of the lengthwise barrel segment with screw shown in FIG. 10, illustrating the orientation of the magnetic flux field generated by the induction tunnel coil;

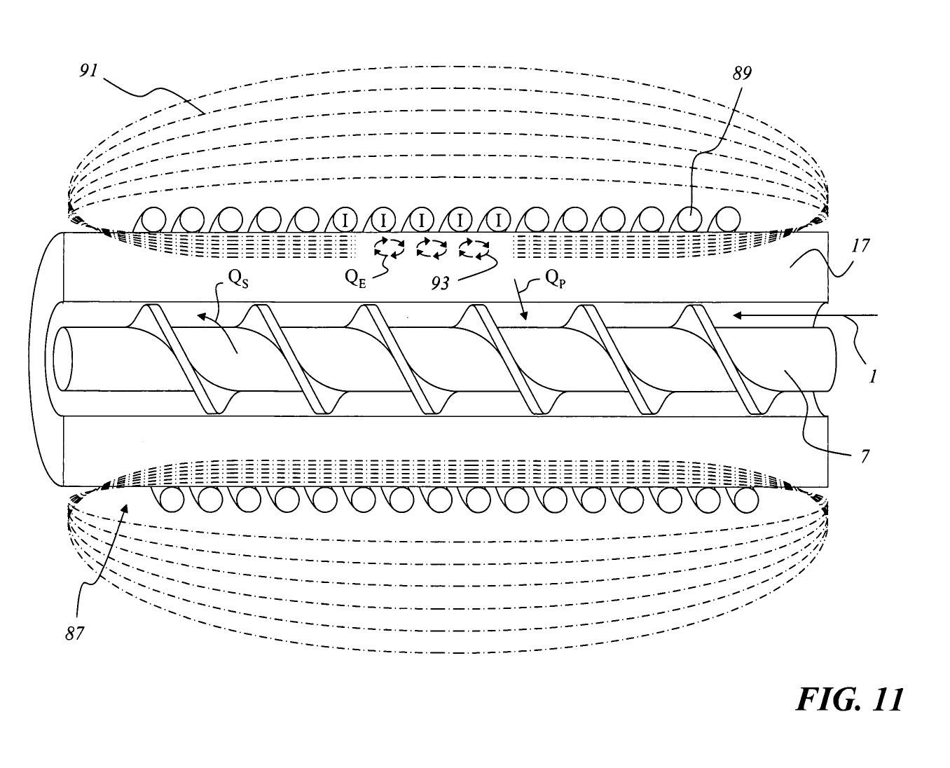

FIG. 12 is a sectional view illustrating the heat balance in the barrel segment shown in FIGS. 10 and 11 without a thermal insulating layer interposed between the induction tunnel coil and the barrel;

FIG. 13 is a sectional-view illustrating the heat balance of a lengthwise segment of the first preferred embodiment of the present invention, comprising an extrusion or molding barrel heated by an induction tunnel coil, with a thermal insulating layer interposed between the windings of the induction coil and the barrel;

FIG. 14a is a partial sectional lengthwise view of a suitable insulating winding template employed by the present invention, and FIG. 14b is a lengthwise view of the same winding template with suitable induction windings wrapped around it;

FIG. 15a is a lengthwise view of an insulating sleeve with induction windings wrapped around it, with a partial cutaway showing the interposed relationship between the barrel and insulating sleeve, and FIG. 15b is a sectional lengthwise view of another insulation embodiment with a thinner similar insulating sleeve surrounded by a separate winding template;

FIG. 16 is a lengthwise view of the molding barrel shown in FIG. 1, but heated by three zones employing the first preferred embodiment of the present invention, rather than by conventional resistance heaters;

FIG. 17 is a graphical illustration of the time-averaged power distribution using induction heating along the length of the barrel shown in FIG. 16 during production conditions;

FIG. 18 is a graph showing the relationship of a tunnel coil's generated heat input density to winding density, where the heat input density substantially equals the power transferred to the workpiece per unit length of coil, and the winding density equals the number of winding turns per unit length of coil;

FIG. 19 is a lengthwise view of the molding barrel also shown in FIG. 16, but illustrating the barrel being heated by a second embodiment of the present invention;

FIG. 20 is a graphical illustration of the time-averaged power distribution during production conditions of a contiguous step-wise power profile, using a single zone along the length of the barrel shown in FIG. 19;

FIG. 21 graphically shows the normalized profile 133 of the heater power distribution illustrated in FIG. 20, the normalized cumulative power input profile 135 derived by integrating 133, a smoothed normalized cumulative power input profile 137 derived by a least-squares curve-fit of 135, and a continuous heater power distribution profile 139 derived by taking the derivative of 137;

FIG. 22 graphically shows the normalized continuous power distribution profile 139 shown in FIG. 21, in relationship with the normalized continuous winding density profile 141 derived by taking the square root of 139, and the normalized continuous pitch profile 143 derived by taking the reciprocal of 141, thereby illustrating the continuous, variable winding pitch principle of a third embodiment of the present invention;

FIG. 23 is a lengthwise view of the molding barrel shown in FIGS. 16 and 19, but illustrating the barrel being heated by the fourth embodiment of the present invention; and

FIG. 24 is a graphical illustration of the time-averaged power distribution combining the profile of one zone having one pitch, with a second zone having multiple pitches, along the length of the molding barrel shown in FIG. 23, during both production conditions and initial barrel heat-up.

### DETAILED DESCRIPTION OF THE PREFERRED EMBODIMENTS

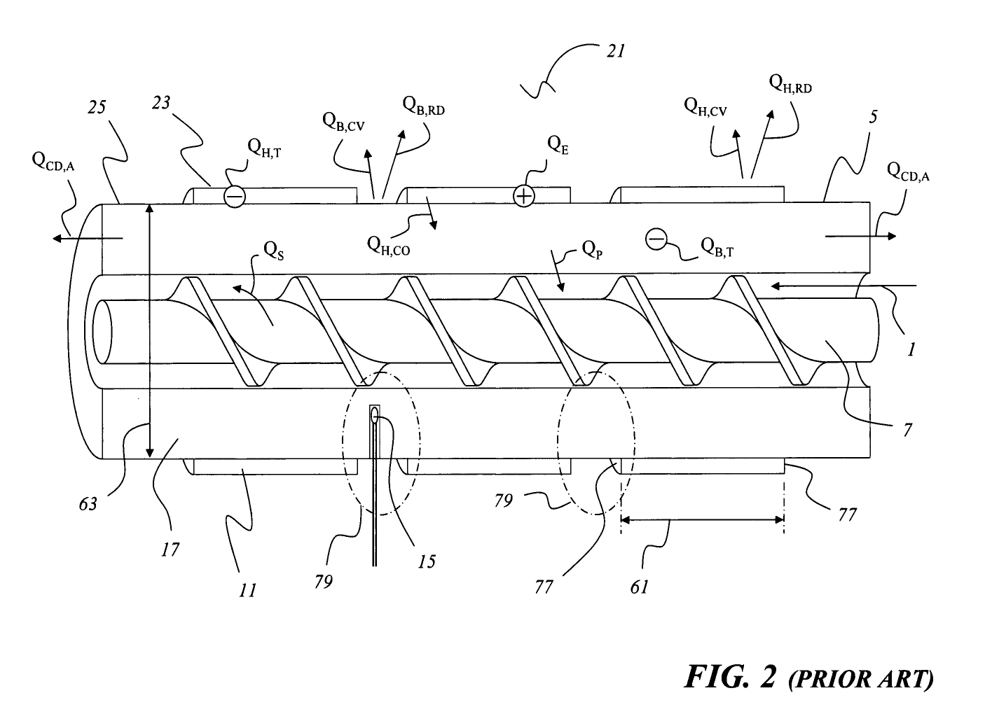

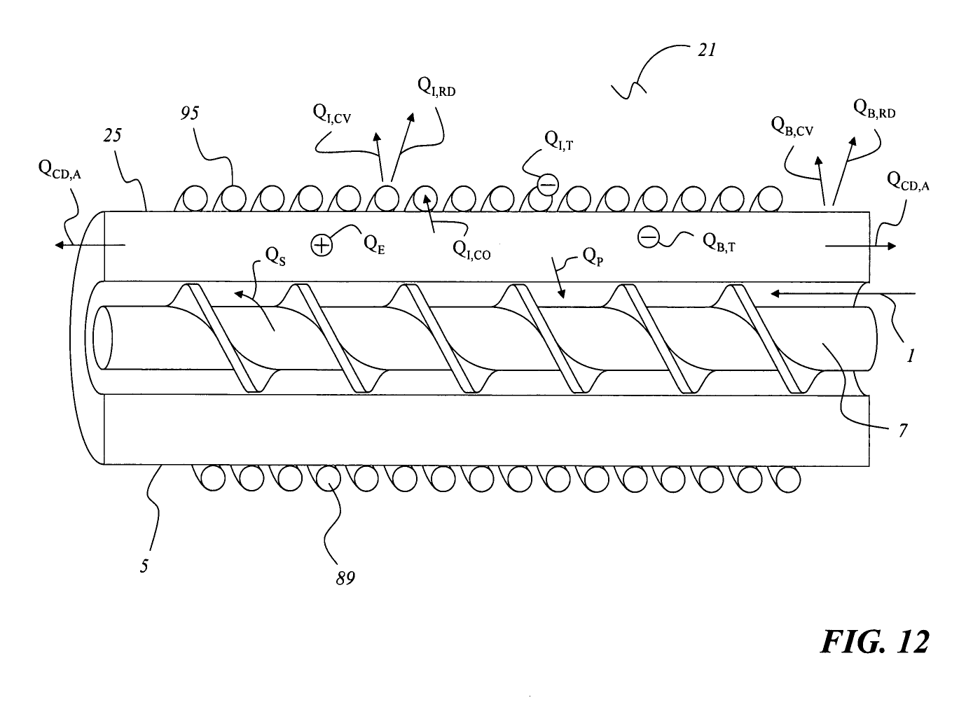

This discussion begins with reference to FIGS. 2 and 12 to make a comparison of some of the primary differences between heating of workpieces, such as barrels 5, with conventional resistance heaters 11 versus induction heaters with windings 89. Notably, the induction heater generates heat Q_{E} directly within the workpiece, while resistance heating must drive heat Q_{H,CO} across the contact interface between the resistance heater 11 and the barrel 5. In practice, this allows induction heating to heat the barrel 5 more quickly, even when the windings 89 are in thermal contact therewith. However, the induction windings 89 being in thermal contact with the barrel 5 will create additional thermal mass in the apparatus that will, like that of resistance heaters 11, absorb heat Q_{I,T}, thereby slowing the thermal response of the system. Even if the windings 89 do not generate significant resistive heat within themselves, heat Q_{I,CO} will conduct across the interface between the heated barrel 5 and the contacting windings 89. Still further, the induction windings 89, being in thermal contact with the barrel 5, will also get hot, causing their exposed surfaces 95 to dissipate heat through convection Q_{B,CV} and radiation Q_{B,RD} to the surrounding environment 21. Further, the exposed barrel surface 25 between the windings 89 will lose heat through convection Q_{I,CV} and radiation Q_{I,RD} to the environment.

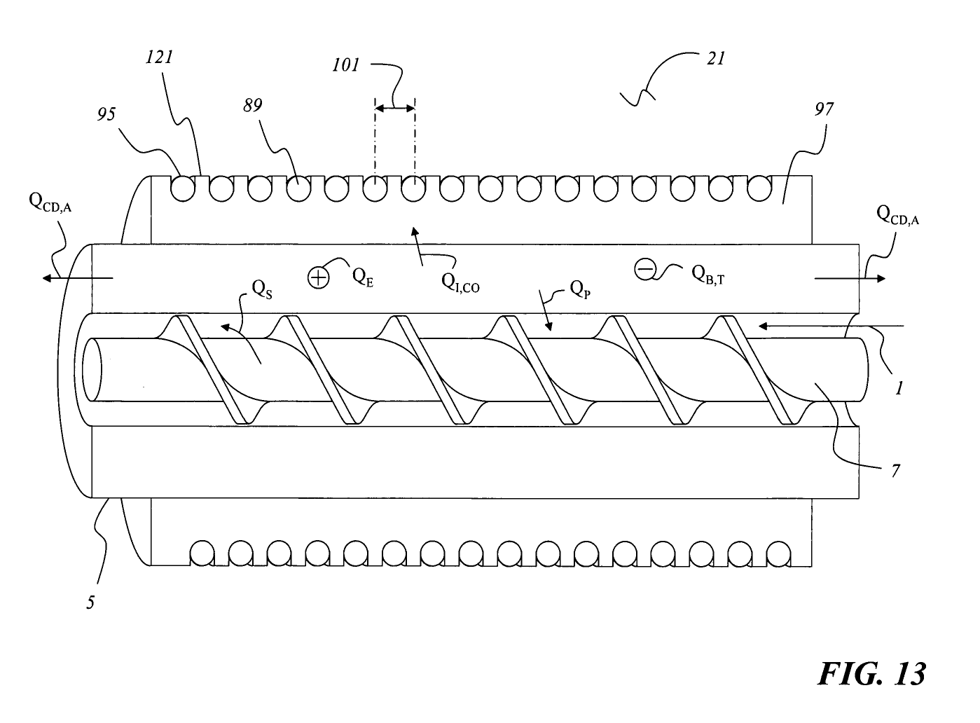

Referring now to FIGS. 12 and 13, when the induction windings 89 are separated from the barrel 5 by an interposed layer of thermal insulation 97, the windings 89 are thermally isolated from the barrel 5, essentially eliminating heat absorption Q_{I,CO} by the windings 89, as well as heat losses Q_{B,CV}, Q_{B,RD}, Q_{I,CV}, Q_{I,RD} from their exposed surfaces 95 to the environment 21. The unique non-contact principle of induction heating allows the induction windings 89 to generate heat within the barrel 3 through the interposed thermal insulating layer 97, thereby effectively eliminating not only the heat losses Q_{B,CV}, Q_{B,RD}, Q_{I,CV}, Q_{I,RD}, to the environment 21, but also any thermal mass otherwise attributable to the induction windings 89.

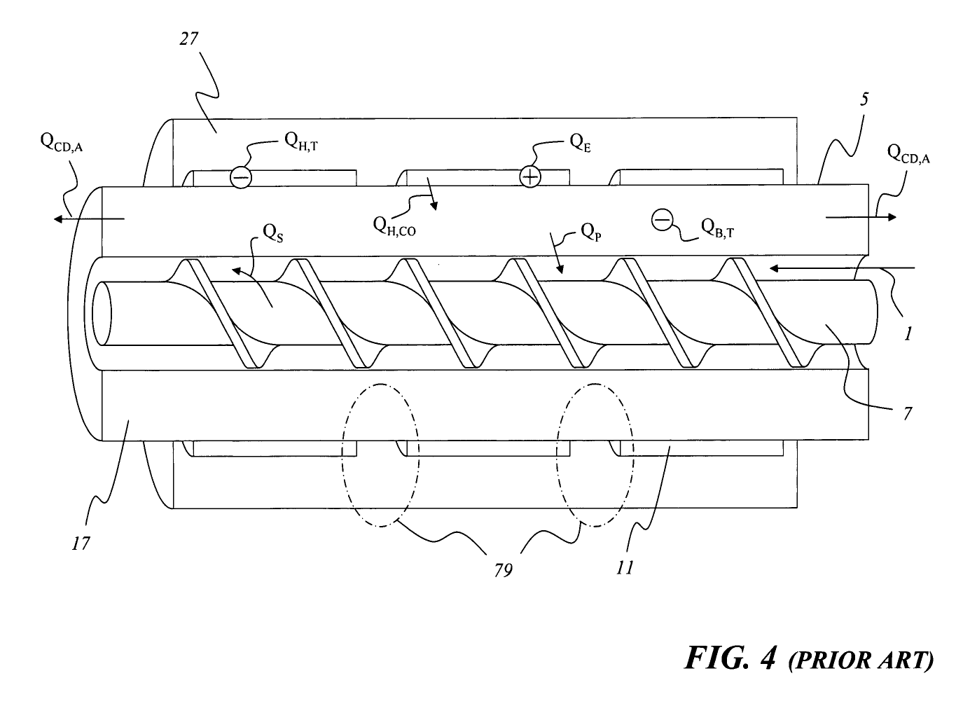

In contrast, referring again to FIGS. 2 and 4, resistance heaters 11 must be in direct contact with the barrel 5. Therefore, thermal insulation 27 intended to effectively eliminate heat losses Q_{B,CV}, Q_{B,RD}, Q_{H,CV}, Q_{H,RD}, to the environment 21 cannot be interposed between the resistance heaters 11 and the barrel 5. Instead, the thermal insulation 27 must surround the resistance heaters 11. Accordingly, insulated resistance heaters 11 are not thermally decoupled from the barrel 5, thereby attributing thermal mass which slows the thermal response of the system.

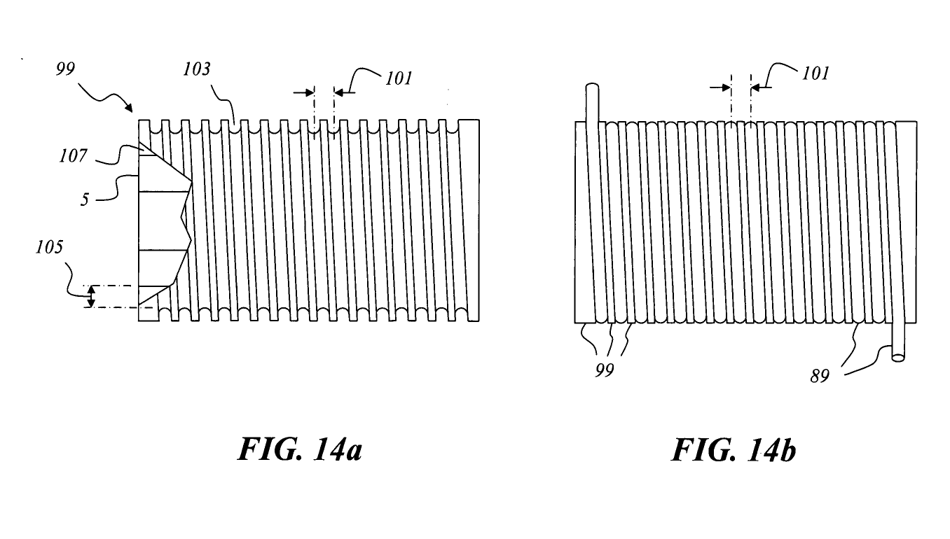

Referring now to FIGS. 14a and 14b, this embodiment of the present invention employs an insulating winding template 99 that will surround the barrel 5 and serve one or a combination of three purposes. The first and most critical purpose is to thermally insulate the barrel 5 from the windings 89 and the environment 21. The second purpose is to support the windings 89, and the third is to set and constrain the pitch 101 of the windings 89 by means of winding grooves 103. The insulating winding template 99 will typically be cylindrical in shape, with an insulating wall thickness 105 of between 5 and 35 mm, made from a thermal insulating material that is sufficiently durable, and which has a suitably low thermal conductivity of typically less than 1 btu-inch/hr-ft²-° F. The preferred insulating material 107 will also be cost-effectively moldable or machineable, allowing incorporation of the winding grooves 103. A suitable insulating material 107 of this type, for example, would be Gemcolite, manufactured by Refractory Specialties Incorporated, wherein the insulating winding template 99 would be vacuum-formed from a slurry of the material. Of course, other moldable refractory materials having similar physical and thermal properties can be used.

Referring to FIGS. 14a and 14b versus 15a for comparison, as an alternative to winding template 99, an insulating sleeve 109 could be used made of an insulating material 111 of a uniform wall thickness 113, that is sufficiently durable, and which has the same suitably low thermal conductivity as described above, that is available in bendable sheet form or semi-rigid tube form, around which the windings 89 would be manually or machine-wound at any desired pitch 101. A suitable insulating material 111 for such use would be Minwool 1200 pipe insulation, manufactured by IIG, Minwool LLC. Of course, other insulating sleeve material having similar geometric, physical and thermal properties can be used.

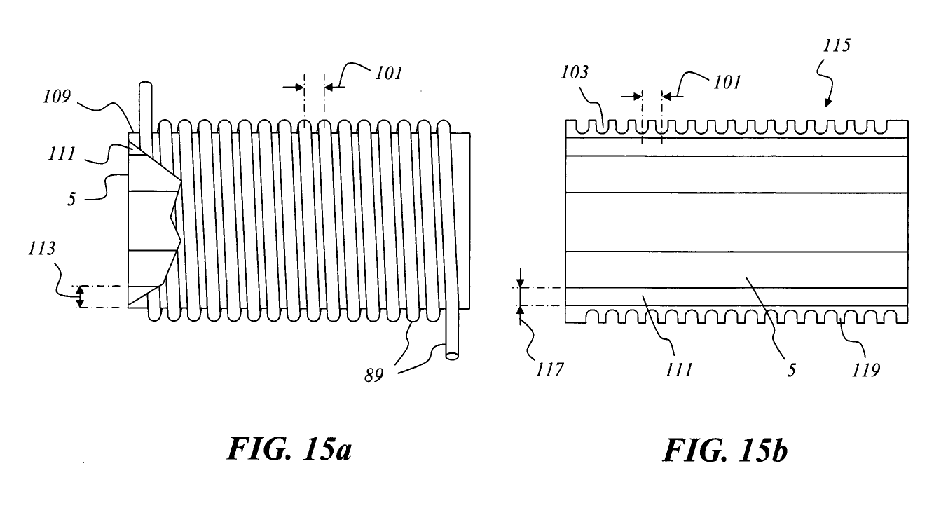

FIG. 15b shows in its combined entirety 115, yet another alternative form of the insulating winding template shown in FIG. 15a, but with a thinner uniform wall thickness 117 and a separate winding template 119. The separate winding template 119 need not, but could have, thermal insulating properties, which would surround the insulating material 111 and incorporate machined or molded winding grooves 103, so as to set and constrain the winding pitch 101.

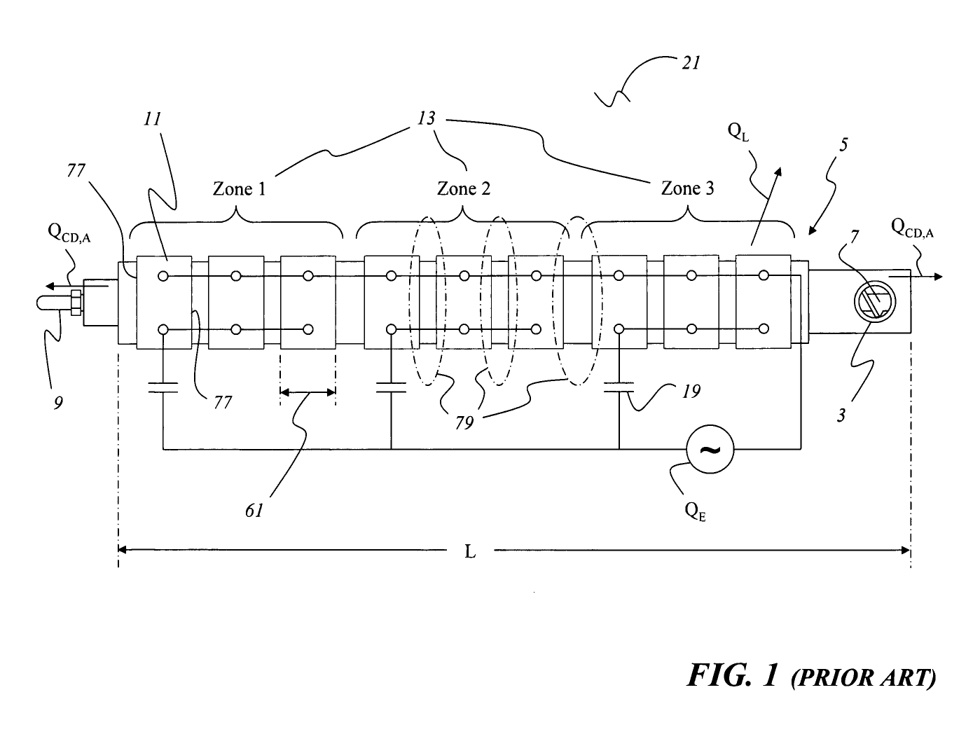

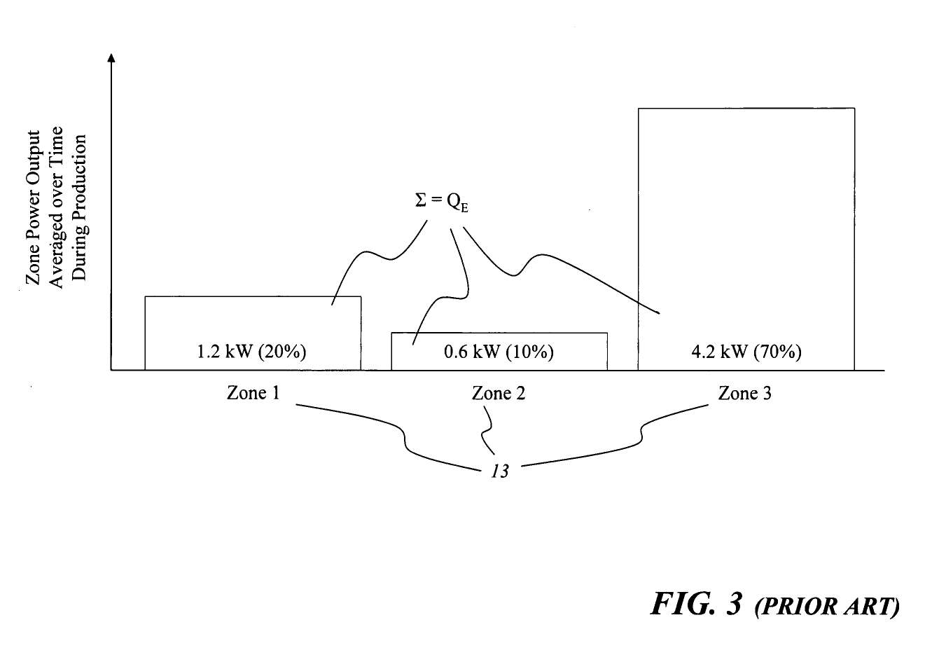

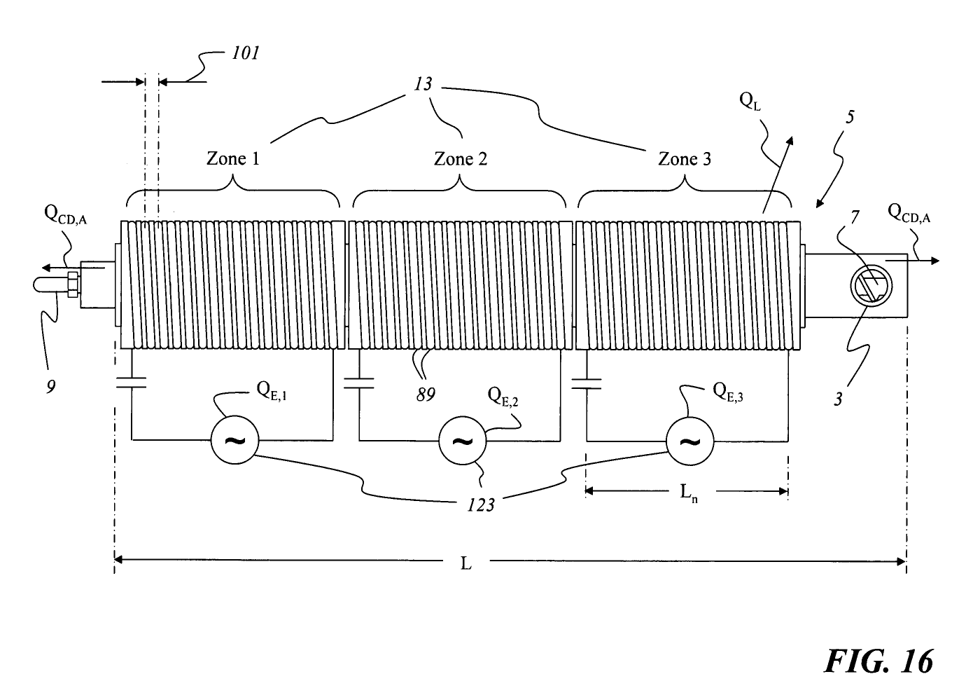

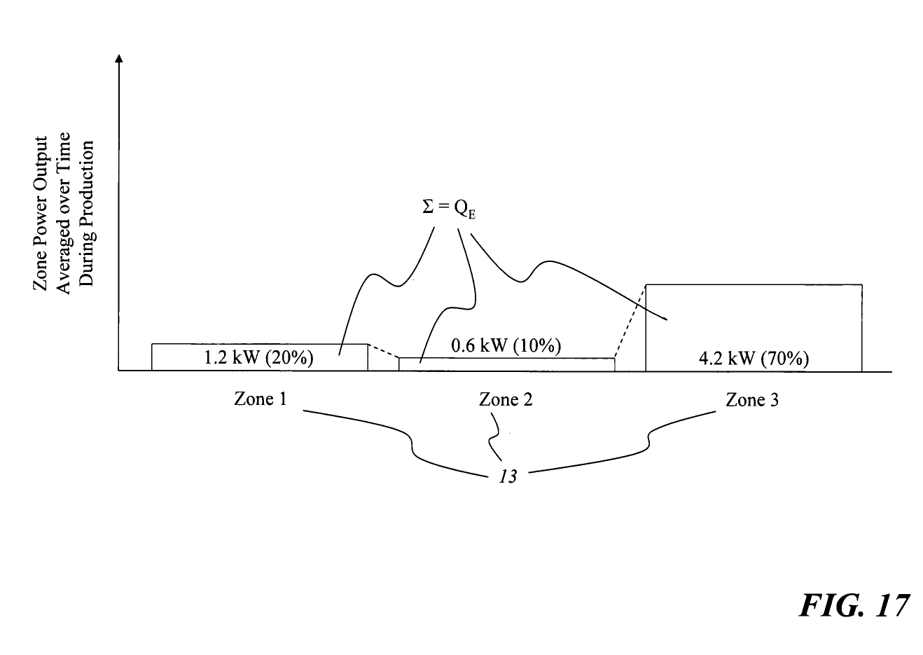

Notably, the use of sleeves 109 or winding templates such as 99 or 115 would essentially eliminate heat losses Q_{L} from exposed longitudinal surfaces, leaving only axial heat losses Q_{CD,A} to the upstream and downstream machine housings. By example, as discussed previously with reference to FIGS. 1, 2 and 3, using a typical resistance-heated injection molding application known in the art, with a screw diameter in the range of about 50 mm, about 5 kW of process heat Q_{P} may be required to heat and/or melt the flowing material 1, while heat losses Q_{L} from the exposed external surfaces 23, 25 could be about 4 kW. In comparison, were the present invention as shown in FIGS. 13 and 16 applied to the same application, heat losses Q_{L} from its relatively cool exposed winding surfaces 95 and thermal insulation surfaces 121 would approach 0 kW. Heat losses to the machine housings Q_{CD,A} would be about the same—about 1 kW. Likewise, in this representative example, the shear energy Q_{S} generated by friction between the processed material 1, screw and barrel wall 17, is calculated to be the same in both cases, or about 4 kW, assuming the process operating conditions remain the same. Accordingly, and as indicated by comparing FIGS. 3 and 17, the application of the preferred embodiments of the present invention would reduce the required heating system power Q_{E} from about 6 kW to 2 kW, for a reduction in heating system energy consumption of 4 kW, or about 67%. This demonstrates that by virtually eliminating the barrel surface heat losses Q_{L} shown in FIGS. 1 and 2, this invention significantly improves heating efficiency and accomplishes the many objectives stated above.

Referring to FIG. 16, the first preferred embodiment of the present invention could employ the sleeve 109 or winding templates 99, 115 wound with suitable windings 89, such as Litz cabling. Litz cable is well known as an effective induction heating winding and is commonly used at high frequencies because of its high current-carrying capacity with minimal electrical resistance. As a result, resistive losses in the windings can be reduced to less than 5%, thereby substantially eliminating heating in the coil and raising its overall heating efficiency to over 95%. By comparison, conventional resistance heaters 11 that lose heat to the surrounding air, or to a flow of water or forced-air, typically have an overall heating efficiency of 30-60%.

With this invention, the windings 89 can be electrically powered by one or more accompanying inductive power supplies 123 designed to generate the desired amount of dissipated power Q_{E}(equal to Q_{E,1}+Q_{E,2}+Q_{E,3}+Q_{E,n}, where n is equal to the number of zones) within the barrel 5, by the application to the windings 89 of a proper electrical voltage and total amperage at an appropriate frequency, preferably greater than 60 Hz, and more preferably between 10 to 40 kHz, although lower and higher frequencies can be used. Notably however, high frequency induction in the preferred range will reduce the number of tunnel coil turns needed to transfer a given amount of power, thereby reducing the required length of the winding 89, and the associated electrical resistance losses therein, to further improve efficiency. This will also reduce the total cost of the winding 89, including the labor required to wrap it around the sleeve 109 or winding templates 99, 115.

As a result, the improved efficiency of the present invention can be used to reduce energy consumption and resulting electricity costs, and/or it enables higher throughput in cases where the throughput was previously limited by the capacity of the prior heating means.

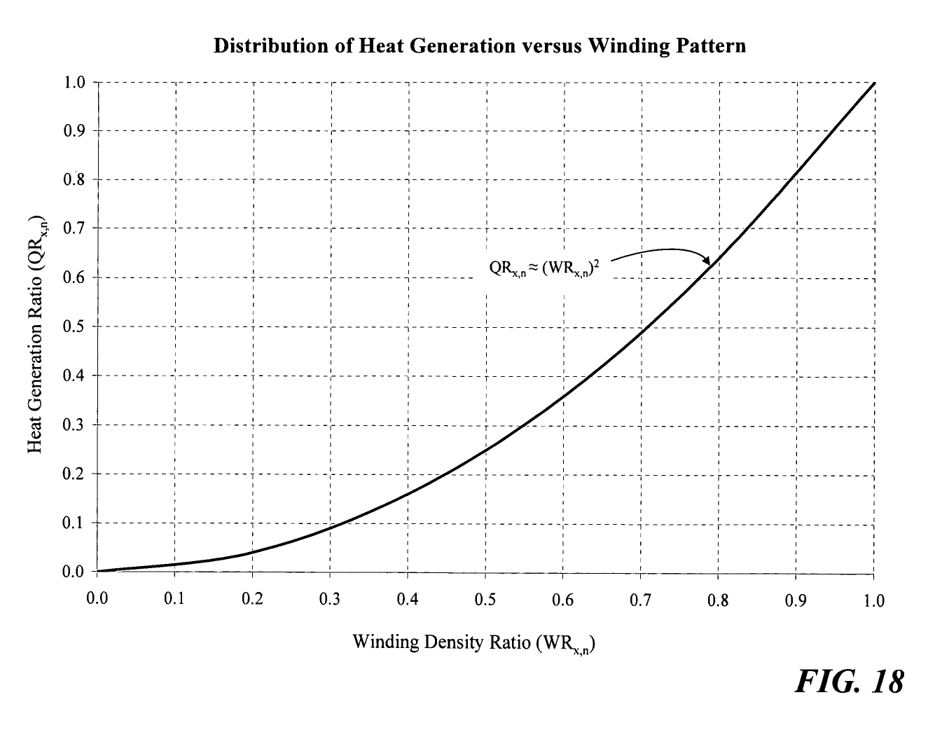

With reference to FIG. 18, an advantage of induction heating using the helical tunnel coil of the present invention is that the distribution of generated heat along the axial length L of the barrel 5 is more substantially proportional to the winding pitch 101. Specifically, the relative amount of heat generated at a given position is in effect inversely proportional to the square of the winding pitch 101 at that position. The relationship between the desired distribution of generated heat and the required winding pattern can thus be defined by:

Q_{E}=ΣQ_{E,n};

Q_{E,n}=∫q_{E,x,n}dx for x=0 to Lₙ;

q_{E,x,n}=QR_{x,n}x q_{E,M,n};

QR_{,x,n}≈(WR_{x,n})²≈(1/PR_{x,n})²; and

WR_{x,n}=W_{x,n}/W_{M,n}=1/PR_{x,n}=P_{m,n}/P_{x,n}; where

W_{x,n}=1/P_{x,n}; and

W_{M,n}=1/P_{m,n}

In this case, Q_{E} is the total heat generated in the barrel 5 by the induction heating system; Q_{E,n} is the heat generated within each “n^{th}” zone 13 in the barrel 5; q_{E,x,n} is the heat generated as a function of the axial position “x” within the length “Lₙ” of the “n^{th}” zone; q_{E,M,n} is the maximum heat generated per unit length within the “n^{th}” zone; QR_{x,n} is the heat generation ratio at position “x” along the length “Lₙ” within each “n^{th}” zone 13; P_{x,n} is the winding pitch 101 at position “x” along the length “Lₙ” within each “n^{th}” zone; P_{m,n} is the minimum winding pitch within each “n^{th}” zone 13; W_{x,n} is the winding density at position “x” along the length “Lₙ” within each “n^{th}” zone 13 (equal to the number of winding turns per unit length); W_{M,n} is the maximum winding density within each “n^{th}” zone 13; WR_{x,n} is the winding density ratio at position “x”, as described above; and PR_{x,n} is the pitch ratio at position “x”, as described above.

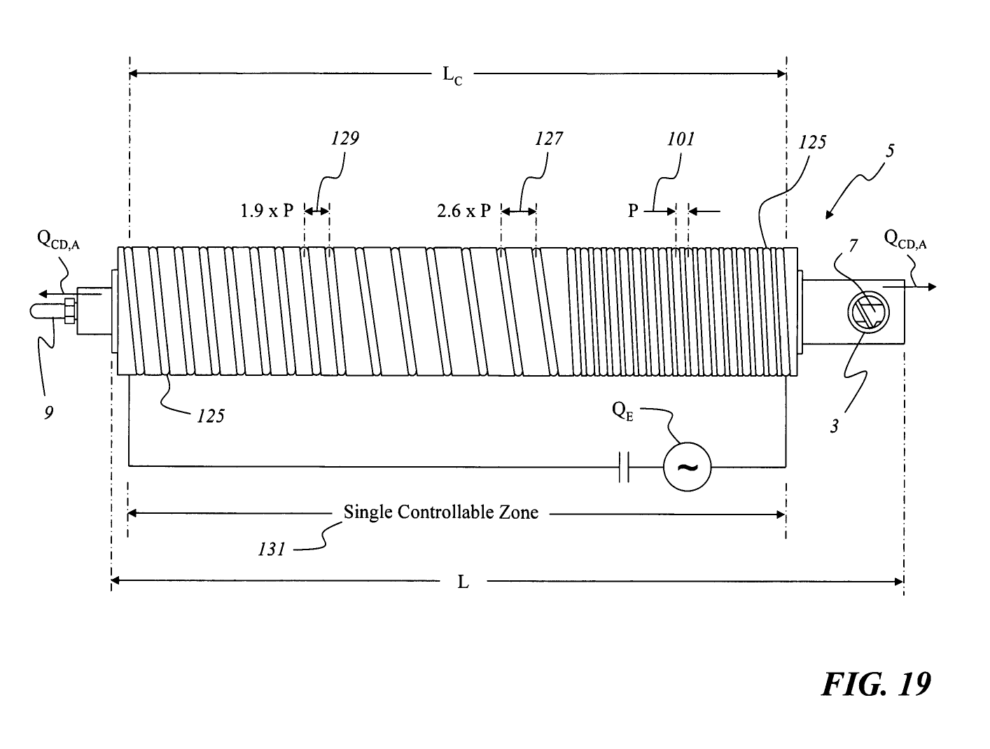

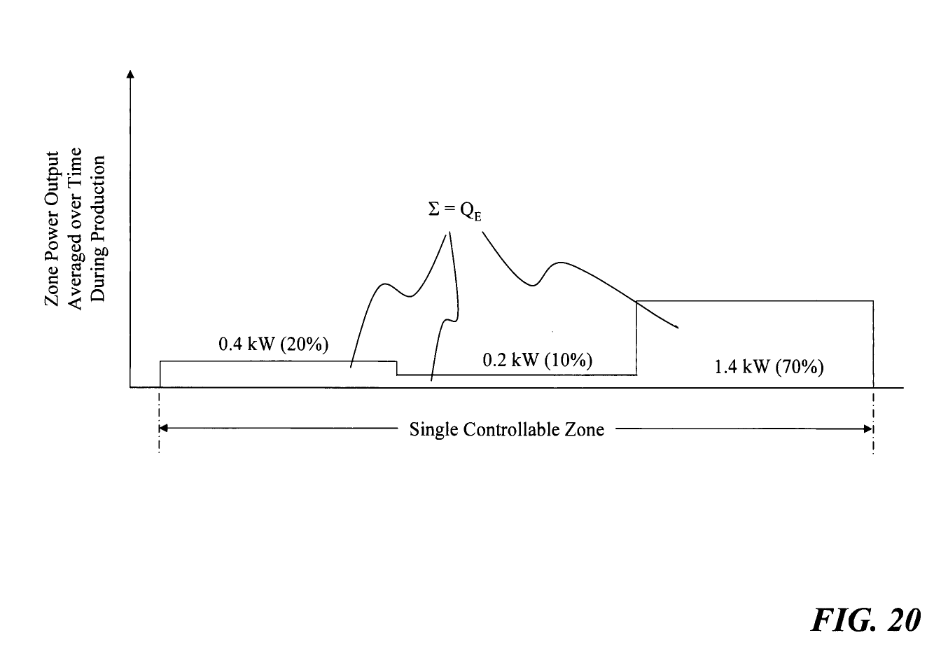

Based on the relationship between the distribution of power consumption, and in this case heat generation, versus the winding density, as described above and illustrated in FIG. 18, the winding pitch 101 (which is the reciprocal of the winding density) can then be varied to achieve a desired heat input profile. This then is the basis of the second preferred embodiment of the present invention, which is best illustrated with reference to FIGS. 19 and 20. Referring thereto, in comparison to FIGS. 16 and 17, instead of using three separately controlled zones 13 as shown in FIG. 16, each having the same uniform winding pitch 101 to produce the discontinuous or broken step-wise power transfer profile shown in FIG. 17, the second preferred embodiment of the present invention illustrated in FIG. 19, employs a single contiguous winding 125, using three different pitches 101 (P), 127 (2.6×P) and 129 (1.9×P) within a single controllable zone 131, to transfer the same total power Q_{E}, but with the contiguous step-wise power profile as illustrated in FIG. 20. Of course, the various pitches suggested here, and the ratio between them, are merely exemplary, as the optimal pitches may differ in practice from one application to another.

Referring still to FIG. 19, while the example illustrated here uses a contiguous winding 125 with three different discrete pitches 101, 127 and 129, it should be understood that the second preferred embodiment of the invention may use any number of continuously or discretely varying pitches over the length “L_{C}” of the contiguous winding 125.

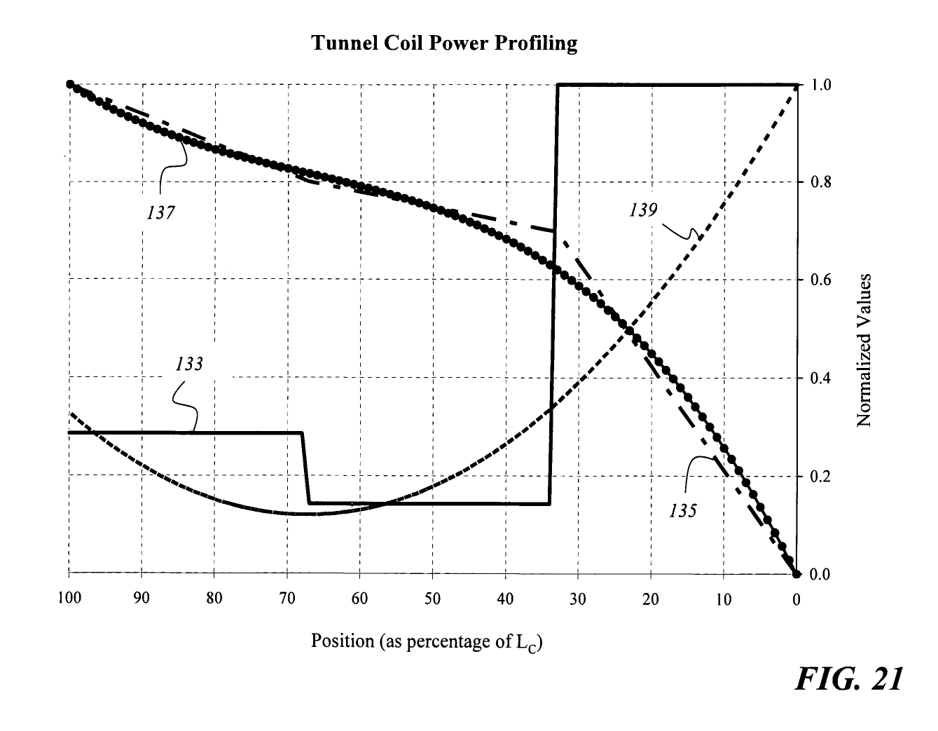

Referring now to FIG. 21, the contiguous step-wise power profile produced by the second preferred embodiment of the present invention can be normalized (power at position x versus maximum power over length L_{C} of the contiguous winding) to 1 and re-plotted as line 133 on a 0-to-1 scale, versus position (represented here as the percentage of L_{C}—from 0 to 100). The step-wise normalized power profile 133 can then be integrated from 0 to L_{C}, and then normalized again, to plot the normalized cumulative power profile 135 from 0 to L_{C}.

Referring still to FIG. 21, a suitable least-squares curve-fit (such as a 3-degree polynomial) of the normalized cumulative power profile 135 can be used to derive a smoother, continuous cumulative power profile 137, which is the basis for the third preferred embodiment of the present invention. The derivative of this smooth cumulative power profile 137 can then be developed and re-normalized to draw a smooth, continuous normalized power profile 139 that is a close fit to the original step-wise normalized power profile 133. A smoothly varying contiguous pitch profile can then be employed by the third preferred embodiment of the present invention to produce this smooth normalized power profile 139.

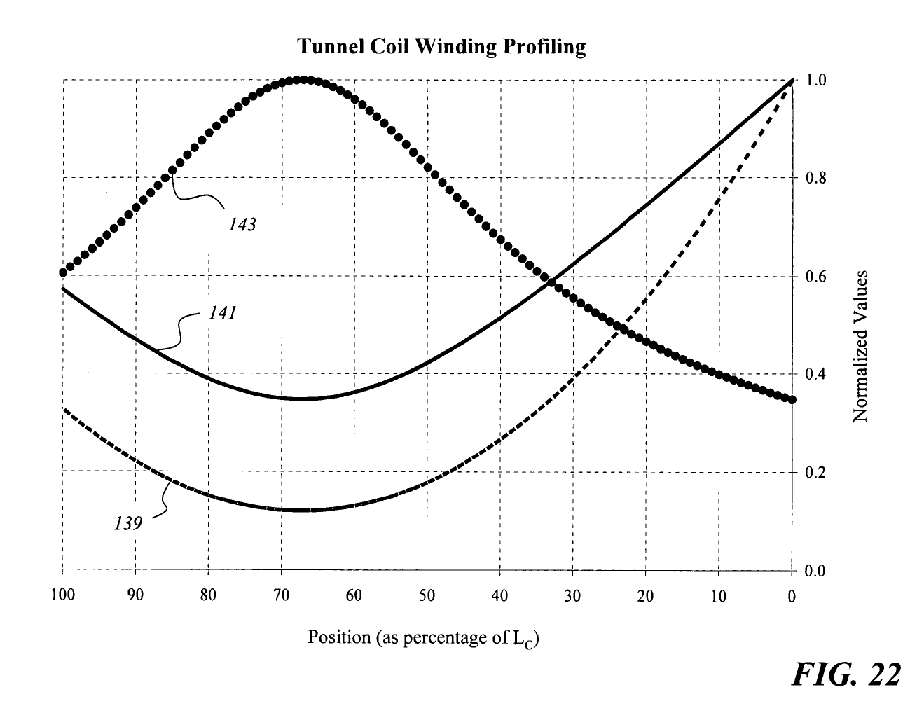

Referring now to FIGS. 18, 21 and 22, and in keeping with the relationship defined in FIG. 18, the square-root of the normalized power profile 139 can be computed and re-normalized to develop the normalized winding density profile 141, the normalized reciprocal of which is the normalized pitch profile 143. Either of the normalized winding density or pitch profiles, 141, 143 respectively, can be employed by the third preferred embodiment to produce an insulated winding template with a continuously varying pitch that will produce a predictable heating profile along the length of the barrel 5. The above-described modeling procedure describes one rational means to easily compute the preferred continuously varying pitch profile of the winding employed by the third preferred embodiment of the present invention. Of course, insubstantial variations may be made to the model to derive the substantially same pitch profile.

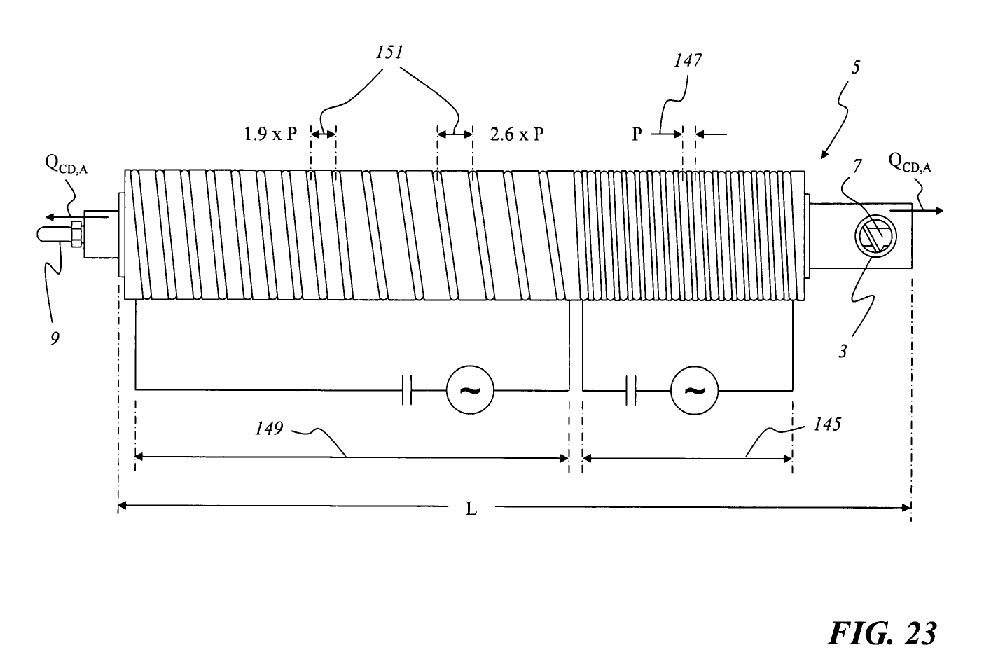

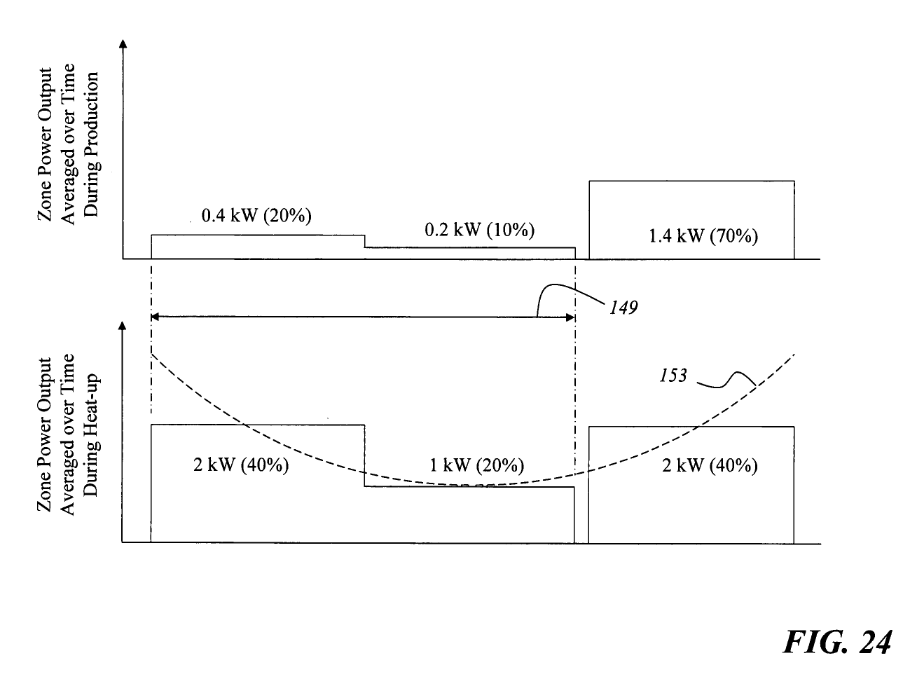

Referring now to FIGS. 23 and 24, still a fourth preferred embodiment of the present invention combines one individually controllable zone 145 having one pitch pattern 147, with one or more additional zones 149 having one or more other pitch patterns 151. The unique advantage of this embodiment can be best understood by considering how the second and third embodiments of the present invention will affect the temperature of the barrel 5 during initial heat-up.

For comparison, reference is made to FIGS. 16, 17, 19 and 20. Intentional non-flat power distribution profiles, such as those shown in FIGS. 17 and 20, are primarily intended to satisfy non-flat process heat input requirements during normal production conditions; i.e. when the material being processed 1 needs to be heated. However, during start-up conditions, when there is no material flow and the sole objective is to heat the barrel 5 to the desired, uniform initial operating temperature, either of the power profiles shown in FIGS. 17 and 20 (which graphically illustrate heater power distribution of a discontinuous step-wise power transfer profile along the length of the barrels shown in FIGS. 16 and 19, respectively) will provide a non-flat initial temperature profile in the barrel that may be undesirable. This is more likely the case with molding applications where the heating zone 13 in proximate relationship to the screw's feed section “A” provides most of the total heat input Q_{E} during production (i.e. typically 60-80%), hence requiring a substantially non-flat power transfer profile along the length L of the barrel 5.

Now, referring back to FIGS. 23 and 24, the problem described above can be largely overcome by the fourth embodiment of the present invention which combines one individually controllable zone 145 having one pitch pattern 147, with one or more additional zones 149 having one or more pitch patterns 151. While the pitch patterns 147, 151 in either zone 145, 149 may be fixed, varied in steps, or varied continuously, this fourth preferred embodiment uses a fixed pitch 147 in the zone 145 nearest the feed port 3, and a step-wise varying pitch 151 in the remaining, longer zone 149. Particularly with respect to injection molding applications, during continuous production this arrangement can produce a desirable, highly non-flat power transfer profile as graphically shown in FIG. 24, yet during startup, when the barrel 5 is heating up, independent control of the longer zone 149 can raise the heat input profile over the adjacent length of the barrel to generate a far more flat initial temperature profile than would otherwise be possible. In practice, the result is an essentially concave power profile 153 that provides additional valuable advantages during startup. Among others benefits, this concave heating profile 153 can be applied during heat-up conditions to symmetrically deliver more heat towards the ends of the barrel 5, to better compensate for initial heat losses Q_{CD,A} to the upstream and downstream machine housings.

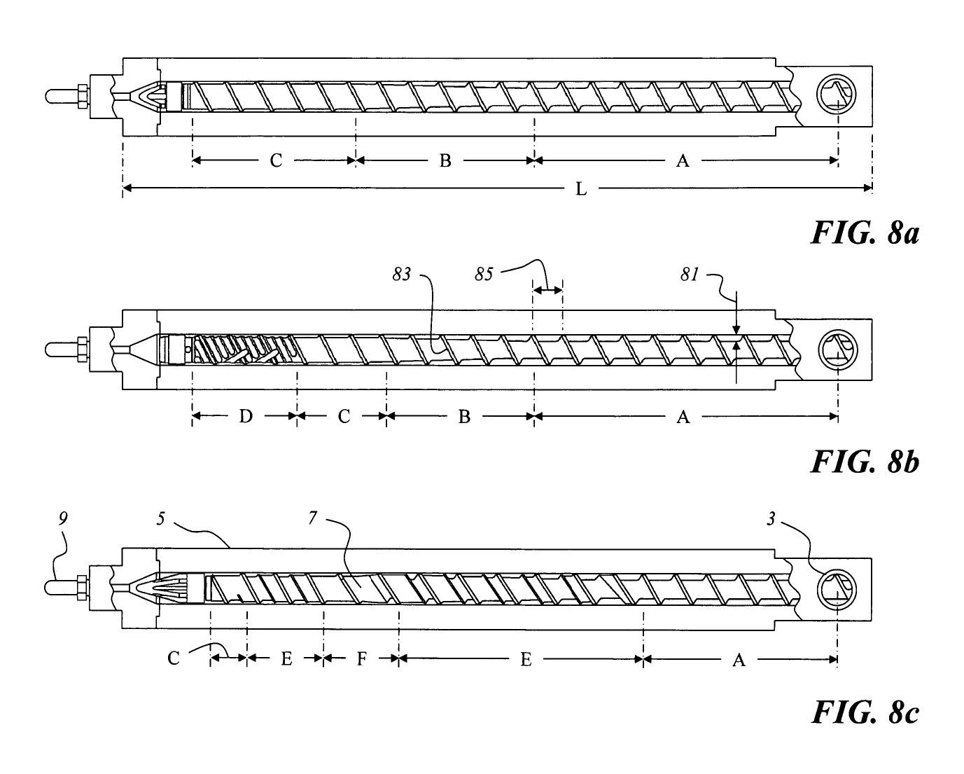

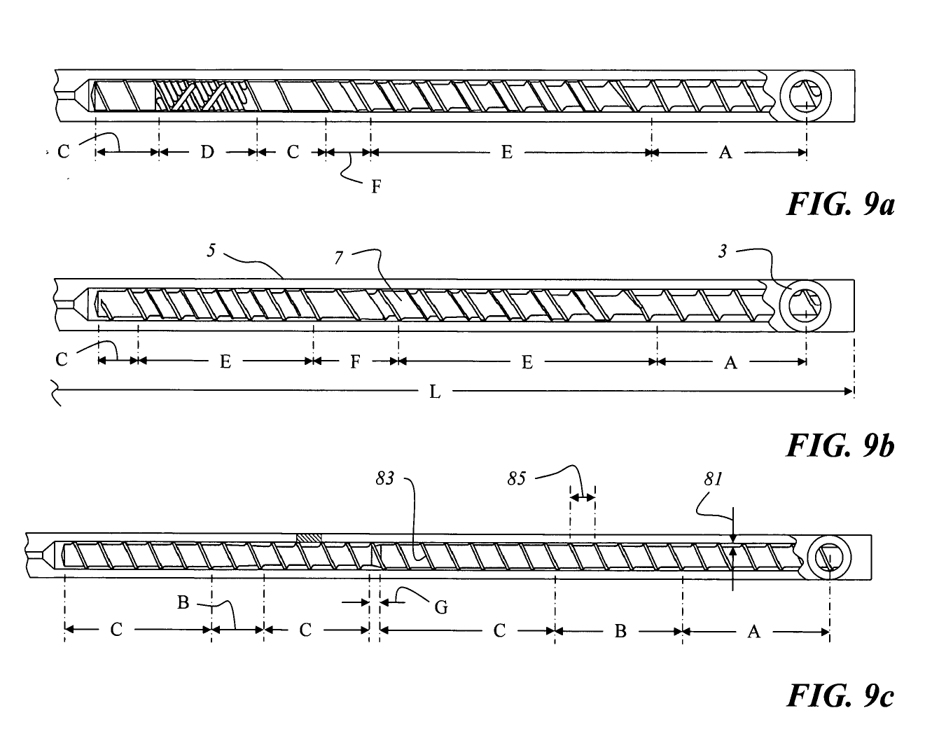

The ability to profile the heat input Q_{E} to the barrel 5 along its axial length L, within a controlled zone 13, and/or across the transition from one zone to the next, during start-up and normal process conditions, offers many advantages. Multiple screw designs are used for extrusion and molding, such as, for example, those commonly referred to as general purpose screws, mixing screws, barrier screws, and vented screws. FIG. 8a shows a commonly used general purpose screw, while FIG. 8b shows a mixing screw; both used for injection molding. FIG. 8c is an example of a barrier screw used for injection molding, and FIGS. 9a and 9b show different barrier screws used for extrusion. Finally, FIG. 9c is an example of a vented screw used in extrusion machines. It is well known that the optimum temperature profile differs with screw design, material 1 and between extrusion and molding applications. For example, polyethylene and ABS typically prefer the temperature to ramp up along the length L of the barrel 5, while polypropylene and nylon generally prefer a reverse temperature profile, and with a barrier screw application the desired maximum temperature is typically near the middle.

Currently, these different requirements are only partially satisfied using discrete resistance heaters. The flexibility and predictability available with the present invention, to produce a continuously varying heat input pattern, can be used by molding and extrusion machine designers to better optimize the process. One example of how profiled heating can improve extruder or molding machine performance relates to the elimination or lessening of process temperature constraints encountered with discrete resistance-heated control zones 13. Take, for example, the situation where the throughput might be limited by a minimal allowable temperature at one location along the barrel 5 being apt to cause excessive shear Q_{S}. With discrete resistance heaters it may not be possible to simply add more heat Q_{E} to the relevant zone 13, as doing so may cause overheating and compositional degradation and/or burning of the process material 1 elsewhere within the zone 13, or downstream of the zone. The solution can be to use one of the several embodiments of the present invention to better profile the heat input Q_{E} upstream and downstream of the zone 13, and/or variably within the zone, during start-up and/or normal process conditions, to permit an increase in throughput, and thereby productivity.

In accordance with the provisions of the patent statutes, the present invention has been described in what is considered to represent its preferred embodiments. However, it should be noted that the invention can be practiced otherwise than as specifically illustrated and described without departing from its spirit or scope. It is intended that all such modifications and alterations be included insofar as they come within the scope of the appended claims or the equivalents thereof.

The invention claimed is:

1. A heating apparatus comprising:
an electrically conductive barrel having a length, an upstream feed section and a downstream output section;
a screw disposed within the barrel having a helical flight cooperating with an inner wall of the barrel to form a flow channel having a depth traversing in a helical direction; and
an inductive heating unit along the barrel length and a layer of thermal insulation interposed between an induction winding of the induction heater and an outer wall of the barrel, a pitch of the induction winding complements a corresponding screw flow profile.

2. The heating apparatus of claim 1, wherein the induction winding has a varied pitch to generate different heat input profiles along at least a portion of the length of the barrel.

3. The heating apparatus of claim 1, wherein the induction winding has a constant pitch to generate a uniform heat input profile along the length of the barrel.

4. The heating apparatus of claim 2, wherein the pitch of the induction winding is continuously changing along a zone of the barrel length.

5. The heating apparatus of claim 2, wherein the pitch of the induction winding includes a step increase or step decrease.

6. A plasticizing device having a screw with an upstream feed section, a downstream output section and a helical flight disposed within and cooperating with an inner wall of a barrel to form a flow path having a depth and traversing longitudinally in a helical direction, the device comprising:
an inductive heating unit along an outer wall of the barrel having an induction winding that complements the screw flow path; and
a layer of thermal insulation interposed between the induction winding and the outer wall of the barrel.

7. The device of claim 6, wherein the induction winding has a pitch pattern that substantially complements the depth of the flow path of the screw.

8. The device of claim 6, wherein the pitch of the helical flight of the screw changes and the induction winding has a pitch pattern that substantially complements the varied pitch of the helical flight.

9. The device of claim 6, wherein the induction winding has a pitch pattern that substantially complements both the depth of the flow path of the screw and a varied pitch of the helical flight.

10. The device of claim 7, wherein the pitch pattern of the induction winding is continuous and has a substantially constant changing pitch along a zone of the barrel.

11. The device of claim 7, wherein the pitch pattern of the induction winding is continuous and includes a step increase or step decrease.

12. An apparatus for plasticizing material comprising:
an electrically conductive barrel having a longitudinal axis, along which material moves axially from an inlet to an outlet;
a rotatable screw disposed within and cooperating with an inner wall of said barrel, including an axial core and a feed section;
a main flight having a pitch arranged helically on, and extending radially from the core of the screw forming a channel having a root depth in the axial core in reference to the inner wall of said barrel; and
an induction heater having a longitudinal length along the longitudinal axis of the barrel and a layer of thermal insulation interposed between an induction winding of the induction heater and an outer wall of the barrel.

13. The apparatus of claim 12, wherein the induction winding has a pitch pattern that substantially complements the root depth of the screw channel.

14. The apparatus of claim 12, wherein the pitch of the main flight of the screw is varied and the induction winding has a pitch pattern that substantially complements the varied pitch of the main flight.

15. The apparatus of claim 12, wherein said channel having a cross-sectional area defined by the root depth, main flight and inner wall of said barrel and the induction winding has a pitch pattern along its longitudinal length that substantially complements the cross-sectional area of said channel.

16. The apparatus of claim 12, wherein said channel having a cross-sectional area defined by the root depth, main flight and inner wall of said barrel, said cross-sectional area varying along the axial core of said screw, and the induction winding having a pitch pattern that substantially complements the varied cross-sectional area of said channel.

17. The apparatus of claim 15, wherein the pitch pattern of the induction winding is continuous and a constantly changing pitch along a zone of the barrel.

18. The apparatus of claim 15, wherein the pitch pattern of the induction winding is continuous and has a step increase or step decrease along the length of the barrel.

19. A method of plasticizing using an electrically conductive barrel having a length, the method comprising the steps of:
heating the barrel using an inductive heater;
conveying plasticizable material along the length of the barrel using a screw; and
insulating the barrel by interposing thermal insulation between an inductive winding of the induction heater and a wall of the barrel.

20. The method of plasticizing of claim 19, wherein the induction winding has a varied pitch to generate a heat input profile along the length of the barrel.

21. The method of plasticizing of claim 19, wherein the induction winding has a constant pitch to generate a uniform heat input profile along a zone of the length of the barrel.

22. The method of plasticizing of claim 19, wherein the heating step includes powering the induction winding with a frequency between about 10 to 40 kHz.

23. The method of plasticizing of claim 19, further including a start-up step before conveying, and wherein the start-up step includes profiling power differently along the length of the barrel than during the conveying step.

24. The method of plasticizing of claim 20, wherein the varied pitch pattern of the induction winding substantially complements a varied pitch of a main flight of the screw.

25. The method of plasticizing of claim 20, wherein the screw has a main flight having a pitch forming a channel with a root depth in a core of the screw, a cross-sectional area of the channel is defined by the root depth, main flight and an inner wall of said barrel, the cross-sectional area of the screw channel varying along the length of the barrel, and the varied pitch pattern of the induction winding substantially complements the varied cross-sectional area of the screw channel.

26. The method of plasticizing of claim 20, wherein the pitch pattern at a location in a zone of the barrel is substantially proportional to a square-root of the heat required at the same position within the zone.

27. The method of plasticizing of claim 20, wherein a winding density ratio at a location within a zone of the barrel is substantially equal to a square-root of a required heat input ratio at that same position.

28. The method of plasticizing of claim 25, wherein the pitch pattern of the induction winding is continuous and has constantly changing pitch along a zone of the barrel.

29. The method of plasticizing of claim 25, wherein the pitch pattern of the induction winding is continuous and has a step increase or step decrease along the length of the barrel.

30. A process of plasticating solid plastic material into a molten state under pressure, the process comprising the steps of:
a) feeding solid plastic material with a rotating screw in a barrel having a cylindrical inner surface, said screw having a helical flight with said flight cooperating with said inner surface to form a helical channel having a varied depth to move said material toward an outlet port;
b) applying heat along a length of said barrel using an induction heater to convert the solid plastic material to a solid-molten combination state while moving the material along said helical channel, the induction heater having a length, and a layer of thermal insulation interposed between an induction winding of the induction heater and an outer surface of the barrel;
c) shearing and mixing said solid-molten combination to form a substantially homogeneous molten material having substantially uniform temperature, viscosity, color and composition; and
d) metering said substantially homogeneous molten material though said outlet port.

31. The process of claim 30, wherein the induction winding has a pitch pattern that substantially complements the root depth of the helical channel of the screw.

32. The process of claim 30, wherein the pitch of the helical flight of the screw is varied and the induction winding has a pitch pattern that substantially complements the varied pitch of the helical flight.

33. The process of claim 30, wherein said helical channel having a cross-sectional area defined by the depth of the channel, main flight and inner wall of said barrel, and the induction winding having a pitch pattern along its length that substantially complements the cross-sectional area of said channel.

34. The process of claim 30, wherein said helical channel having a cross-sectional area defined by the depth of the channel, main flight and inner wall of said barrel, said cross-sectional area varying along the helical channel and the induction winding having a pitch pattern that substantially complements the varied cross-sectional area of said channel.

35. The process of claim 30, wherein the heating step includes powering the inductive winding with a frequency between about 10 to 40 kHz.

36. The process of claim 30, wherein the pitch pattern of the induction winding has a continuously changing pitch along a zone of the barrel.

37. The process of claim 30, wherein the pitch pattern of the induction winding has a step increase or step decrease along the length of the induction heater.

38. The method of plasticizing of claim 30, further comprising a start-up step before introducing the solid plastic material in the feeding step, and wherein the start-up step includes profiling power differently along a length of the barrel than after introducing said solid plastic material.

39. The process of claim 30, wherein the screw includes a feed section for feeding solid plastic material through said barrel and a melting section for shearing and mixing said solid-molten combination, and the induction winding having a pitch pattern with a different pitch in the feed section than in the melting section.

40. The process of claim 36, wherein a winding density of the pitch pattern at a position in the zone is substantially proportional to a square-root of the heat required at the same position within the zone.

41. The process of claim 36, wherein a winding density ratio of the pitch pattern at a given position within the zone is substantially equal to a square-root of a desired heat input ratio at the same position.

42. The process of manufacturing a plasticizing apparatus having a barrel with a longitudinal axis, along which material can move axially from an inlet to an outlet, the barrel having a rotatable screw disposed within and cooperating with an inner wall of said barrel, the screw including an axial core and a plurality of plasticizing sections, and the screw further including a main flight having a pitch arranged helically on, and extending radially from the core of the screw forming a channel having a root depth in the axial core in reference to the inner wall of said barrel, the process comprising the steps of:
determining a plurality of heat input ratios along the longitudinal axis of the barrel;
securing a layer of thermal insulation around an outer wall of the barrel;
providing an induction winding of an induction heater along the axis of the barrel over the thermal insulation, so that the insulation is interposed between an induction winding and an outer wall of the barrel, the induction winding having a pitch pattern with a plurality of winding density ratios substantially equal to a square-root of the corresponding heat input ratio at various heat zones arranged in space relationship with the plurality of plasticizing sections.

43. The process of claim 42, wherein the root depth of the helical channel of the screw is varied and a distribution of the heat input ratios substantially complements the varied root depth of said helical channel.

44. The process of claim 42, wherein the pitch of the helical flight of the screw is varied and a distribution of the heat input ratios substantially complements the varied pitch of the helical flight.

45. The process of claim 42, wherein said helical channel having a cross-sectional area defined by the depth of the channel, main flight and inner wall of said barrel, and a distribution of the heat input ratios substantially complements the cross-sectional area of said channel.

46. The process of claim 42, wherein said helical channel having a cross-sectional area defined by the depth of the channel, main flight and inner wall of said barrel, said cross-sectional area varying along the helical channel and a distribution of the heat input ratios substantially complements the varied cross-sectional area of said channel.

47. The process of claim 42, wherein the induction heater has the capacity to power the inductive winding with a frequency between about 10 to 40 kHz.

48. The process of claim 42, wherein the pitch pattern of the induction winding has a continuously changing pitch along at least one zone of the barrel.

49. The process of claim 42, wherein the pitch pattern of the induction winding has a step increase or step decrease along the length of the induction heater.

50. The process of claim 42, wherein the screw includes a feed section and a melting section, and the pitch pattern in the feed section is different than in the melting section.
